(19) United States
(12) Patent Application Publication
(10) Pub. No.: US 2026/0355038 A1
(43) Pub. Date: Nov. 12, 2026

(54) REHABILITATION ROBOT FOR THE LOWER LIMB AND METHOD OF SYNCHRONIZING THE DRIVES OF THE REHABILITATION ROBOT

(71) Applicant: EGZOTECH SP. Z.O.O., Gliwice (PL)

(72) Inventors: Michal MIKULSKI, Gliwice (PL); Marcel SMOLINSKI, Gliwice (PL); Pawel SOJA, Gliwice (PL); Anna ROKSELA, Gliwice (PL); Anna POSWIATA, Gliwice (PL); Dominika KOZAK, Gliwice (PL); Jacek SOLTYS, Gliwice (PL); Katarzyna BIENIAS, Gliwice (PL); Oliver KURGAN, Gliwice (PL)

(21) Appl. No.: 19/515,491

(22) PCT Filed: Aug. 30, 2024
(86) PCT No.: PCT/PL2024/000046

§ 371 Date: Mar. 1, 2026

(30) Foreign Application Priority Data
Aug. 30, 2023 (PL) P.445951
Aug. 30, 2024 (PL) P.449646

(51) Int. Cl. A61H 1/02

(52) U.S. Cl. CPC A61H 1/0255; A61H 1/0266; A61H 2201/1642; A61H 2201/5007; A61H 2201/5061

(57) ABSTRACT

A lower limb rehabilitation robot in the form of a rehabilitation splint enabling lower limb rehabilitation and a method of synchronizing drives of the rehabilitation robot. A lower limb rehabilitation robot comprising a base, a skeleton consisting of two main parts—a thigh support and a calf support and a foot base, which are mutually connected by a joint and at least one separate drive for each main part, and a control system characterized in that the operation of the drives of the individual parts is jointly controlled and synchronized.

The subject of the invention is a rehabilitation robot for the lower limb in the form of a rehabilitation splint enabling the rehabilitation of the lower limbs and a method of synchronizing the drives of the rehabilitation robot.

Known solutions for lower limb rehabilitation braces exist. Patent description P402465 describes a device for the rehabilitation of individuals, particularly those with peripheral nervous system paralysis. This rehabilitation device consists of a control device, a base, an arm attached to a height-adjustable column with an actuator driving the arm's movement, and at least two EMG sensor electrodes. The actuator allows for arm movement within a 120° angular range, and the EMG signal from the sensor connected to the patient's muscle(s) is transmitted to the control module network and via wireless or cable to a remote control device.

The American patent description US 2006/0253052 describes a rehabilitation method for patients with total or partial peripheral nervous system paralysis, manifested by reduced muscle tone or muscle atrophy. This method uses feedback between the signals seen and/or heard by the patient and the intensity of EMG graphs when attempting to move individual muscles. This method is primarily for severely disabled patients as an alternative to AMES therapy.

Patent description US 2004/0106881 also describes a powered device worn around the elbow or another joint, detecting relatively low signals generated by the patient from the spinal cord or other mechanically damaged nerves around the joint. The device responds to these signals to help the patient perform the appropriate movement with the joint.

American patent description U.S. Pat. No. 5,722,420 describes a rehabilitation method using a closed-loop traction force control based on EMG signals from a selected muscle. This method relies on a traction controller that uses a high signal-to-noise ratio EMG signal, scans it, and converts it into units understandable by computer programs, while simultaneously correcting the traction force in real-time using biofeedback control through visual or auditory alerts. The key point of this solution is its ability to adjust traction forces based on real-time EMG signals.

Known solutions that involve muscle electrostimulation to accelerate rehabilitation. Patent description U.S. Pat. No. 10,682,543 B1 describes a lower limb rehabilitation device for passive, active, and resistive range of motion and stretching. It consists of a thigh support link connected to the base by a connector; a leg link configured to support the user's leg and connected to the thigh support link; and a footplate configured to support the user's foot and connected to the leg link. The footplate and leg link can move along the base in response to force applied by the user in one direction and can move along the base in response to force applied by the user in the other direction, with the device configured to apply resistance consistent with the link when moving along the base in the first direction.

In known lower limb rehabilitation brace solutions, limb movement is according to a programmed regulatory algorithm. Such a brace is driven by a single motor controlling the movement of the brace elements supporting the thigh, calf, and foot. This control method does not allow rehabilitated individuals to recreate and build proper limb movement during walking.

The technical problem solved by the invention is to create a brace that allows the recreation of proper lower limb movement during walking and adapts the brace's movement to the individual limb of the patient. This effect was achieved by using separate drives synchronized by a single control system, additionally supported by reading EMG signals from individual muscles, allowing rehabilitated patients to recreate proper muscle initiation for building correct limb movement during walking.

The lower limb rehabilitation robot according to the invention includes a base, a frame consisting of two main parts—thigh support and calf support and foot base, which are interconnected by a joint and at least one separate drive for each main part and a control system characterized in that the operation of the drives of individual parts is jointly controlled and synchronized.

Preferably, the rehabilitation robot includes a module for measuring bioelectrical signals from at least one muscle, where the signal level triggers and controls the motors' movement via the control system.

Preferably, the rehabilitation robot includes a muscle electrostimulation module connected to the control system so that the muscle stimulation sequence is synchronized with the robot's drives' movement according to motion patterns.

Preferably, the rehabilitation robot includes a thigh band with a force sensor and a force sensor mounted in the foot base under the foot connected to the control system.

Preferably, the rehabilitation robot has at least two force sensors in the foot base arranged linearly along the foot, at least under the heel and toes of the patient.

Alternatively, in the rehabilitation robot, the control system can be connected to an external muscle electrostimulation or bioelectrical signal measurement system.

Preferably, the rehabilitation robot has a tablet display on a bracket directed towards the patient's head, which can be mounted on both sides of the device and folded along the device.

Preferably, in the rehabilitation robot, the foot base drive is implemented via a lead screw directly connected to the motor.

Preferably, the drives in the robot are connected by a communication bus to the control system in a manner that enables continuous bidirectional transmission of a signal between the control system and the drives.

A method of synchronizing the drives of a rehabilitation robot for a lower limb according to the invention comprising at least two drives is characterized in that the drives are connected to one control system and one drive is defining the movement and the other is passive, following the movement pattern of the first drive.

Alternatively, each of the drives may function as an active drive defining the movement depending on the exercise being performed.

The rehabilitation robot for the lower limb according to the invention includes at least two drives to support, counteract, or resist lower limb movement, and/or measure bioelectrical signals from one or more circuits, and/or measure the range of motion and position of one or more lower limb joints, and/or a muscle electrostimulation module for one or more circuits, and/or measure the force generated by the lower limb in one or more places. Functional movement patterns' exercises are beneficial for the patient's recovery process. Functional movements are performed by the drives, where each serves to move in a different axis. The drives are synchronized in a functional movement pattern using control algorithms enabling movement in the appropriate range of motion of the lower limb joint with the corresponding force or speed, for example, matching the walking phase.

This solution is possible thanks to the synchronization of the work of two drives, one of which acts as an active drive defining the movement and the movement of the other drive is dependent on the given algorithm and the current work and position of the active drive defining the movement.

The design of the electrical system, thanks to which two drives moving relative to each other are powered and connected by a communication bus in a continuous manner, which makes it possible to control and synchronize them regardless of the position and type of movement performed by the device. The control algorithms work in a synchronized manner between themselves, thanks to which the speed and position of the drives in time are consistent with the planned movement pattern. The control algorithm assumes the designation of a master drive, the signal of which controls both the master drive, but is also used by the following drive as a control signal to ensure synchronization between the two of them.

Which drive is the primary drive at a given moment depends on the given algorithm, i.e. the exercise performed on the robot. For example, in the example of an exercise in which the patient simulates a squat, the active drive is the ankle drive, and depending on the operation of this drive, i.e. the patient's flexion of the foot at the ankle, the movement of the drive in the knee is appropriately guided. In another example, the movement of the knee generates the appropriate movement of the ankle, e.g. an exercise simulating a foot drop, e.g. movement from the thigh tensometer and from under the foot generates movement from the knee and the appropriate movement from the ankle. Here, the function of the active system is performed by the knee drive.

In the rehabilitation process, it is beneficial for the patient to monitor the force of the push and pull movement of the lower limb based on a sensor placed on the thigh. The sensor is located in a band fixing the patient's thigh to the robot's frame. It allows the measurement of the force of both flexion and extension movement initiated from the patient's hip joint.

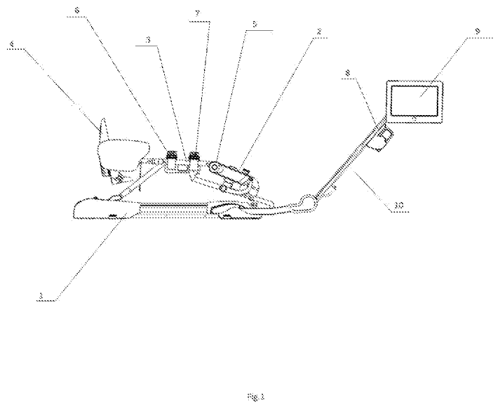

The example implementation of the invention is shown in the figures where FIG. 1 presents a side view of the rehabilitation robot.

A lower limb rehabilitation robot comprising a base 1, a skeleton consisting of two main parts—a thigh-supporting part 2 and a calf-supporting part 3, and a foot base 4, which are mutually connected by a joint 5 and at least one drive 6 and 7 separate for each main part regulating the operation of the rail in the ankle area and in the knee area, and a control system 8, wherein the operation of the drives of the individual parts is controlled jointly and synchronized.

The base 1 is the main element to which the other device modules are mounted. It includes the main drive consisting of a motor, encoder, belt transmission, lead screw (drive screw) with nut (i.e., the moving element responsible for linear motion), and control system. This drive system induces linear motion of the frame, whose construction translates this motion into changes in the knee and hip joint angles. The frame is attached to the base at three points allowing rotation (two fixed mounting points near the patient's buttock at the front of the device and a third linearly movable mounting point to the drive located in the base). The frame consists of two main parts—thigh support 2 and calf support 3, which are interconnected by a joint 5 additionally housing a rotation sensor—a goniometer, measuring the knee joint angle. The calf support part is also mounted to the main drive located in the base, allowing rotation in one axis. The thigh support part is mounted to the device base at two points allowing rotation in one axis. This connection method allows the linear drive located in the base to change the distance between the frame's mounting points to the base during operation, translating to changes in the thigh support part's angle relative to the calf support part, resulting in changes in the knee joint angle. Both frame parts 2 and 3 are equipped with a latch length adjustment mechanism, making the device suitable for patients with different lower limb lengths (from the 5th percentile of women to the 95th percentile of men). Length markings are engraved directly on the frame, allowing convenient reading and setting according to measurements taken on the patient.

The robot has a tablet display 9 on a bracket 10 directed towards the patient's head, which can be mounted on both sides of the device and folded along the device.

The primary advantage of this solution is the ability to recreate walking phases (lifting the leg), i.e., the first two walking phases. The design ensures collision-free operation of both drives in the full range of movement and adjustment. The kinematics of the movement system and the optimization of the dimensions of the structure enable the implementation of two-drive movement. The electronic and mechanical elements of the ankle module are placed on the side of the module—the electronics controlling the engine and drive, and under the foot module—the electronics reading the force from the strain gauges and the strain gauges themselves, providing space for collision-free movement of the ankle module relative to the base, regardless of the extension of the calf length adjustment and the position (angle) of the ankle joint.

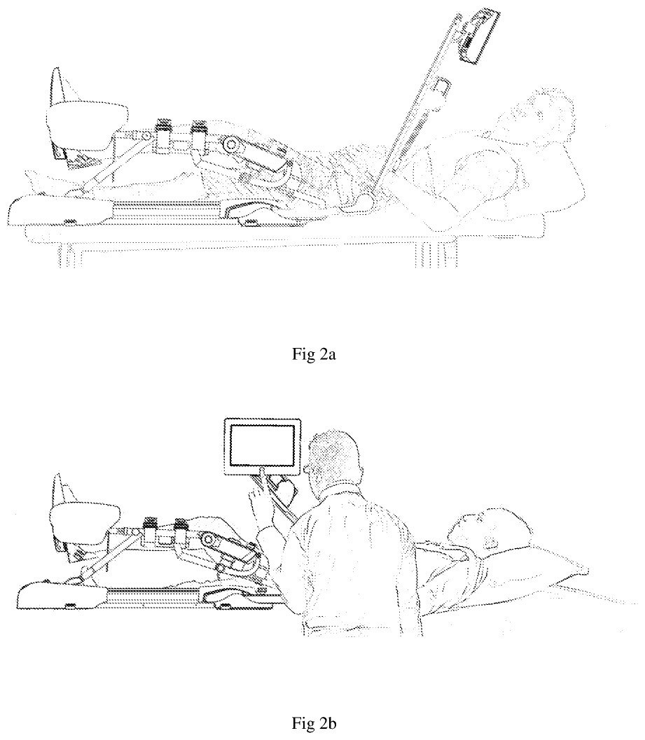

FIGS. 2 a, b shows the mounting method of the bracket to the robot and the patient connected to the robot. The tablet can display feedback on the course of exercises without holding the tablet, as well as games or exercise instructions.

For proper exercise positioning using visual feedback, it is beneficial to place the tablet on a bracket mountable on both sides. The tablet screen is designed to display dedicated content that clearly guides the patient and physiotherapist through the rehabilitation process, increasing exercise efficiency and considering appropriate ergonomics during use. The bracket mounting is angled inward relative to the device's axis, bringing the screen closer to the central axis when unfolded. Alternatively, the bracket allows positioning the screen in the device's central part. This position enables the screen to be operated by the physiotherapist in a seated position. The bracket's tilt covers a 180-degree range, allowing exercises to be performed in a lying position by the patient. The unfolded bracket has a range of 180 degrees and 95 degrees at the ball joint behind the screen, adapting to the patient's anthropometric dimensions (range from the 5th percentile of women to the 95th percentile of men).

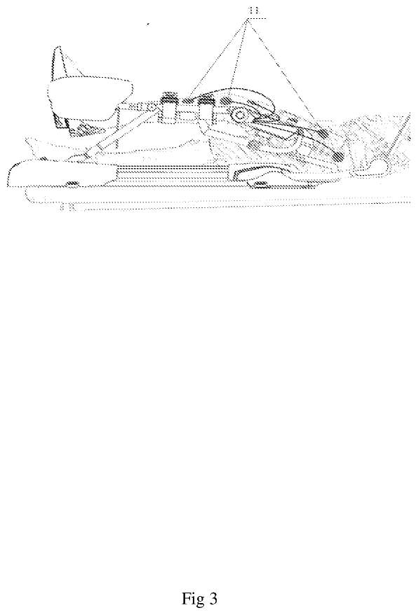

FIG. 3 shows connecting electrostimulation 11 to the patient's leg during exercises.

The robot includes a bioelectrical signal measurement module where the signal level triggers and controls the motors' movement via the control system. EMG sensors can be connected to several muscles in the leg. This solution allows initiating and controlling leg movement depending on the bioelectrical signal level, and connecting to multiple muscles allows controlling proper movement activation (activating appropriate muscles while ensuring the muscles that should be inactive remain so).

The rehabilitation robot includes a muscle electrostimulation module connected to the control system, allowing synchronization of the muscle stimulation sequence with the robot's drives' movement according to motion patterns.

Such a solution, depending on the robot's operating mode and the patient's condition undergoing rehabilitation, allows:
a) Supporting movement through stimulation or activation of muscles that should be activated in a given phase of movement.
b) Strengthening muscles in neurological patients who have muscles too weak to perform movements independently. It is possible to combine this with EMG readings.
c) In orthopedic patients, electrostimulation strengthens muscles after injury.

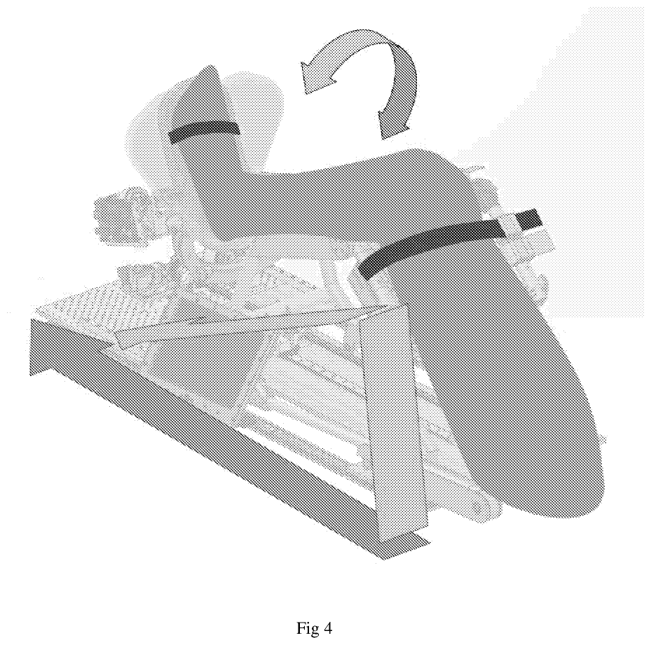

FIG. 4 illustrates the possible range of limb movement on the robot.

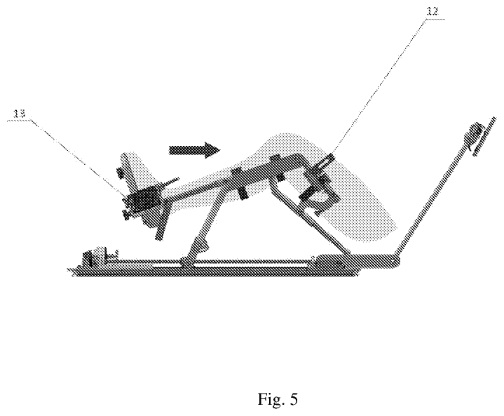

FIG. 5 shows the placement in the robot of a thigh band with a force sensor 12, such as a strain gauge, and a force sensor mounted under the foot base 13 beneath the foot, connected to the control system. Such a combination of sensors allows:

Control over initiating movement from appropriate muscles (activation of the thigh sensor while simultaneously deactivating activation from the foot).

Additionally, the sensors allow for active resistance and squat simulation. In the robot's assisted movement mode, the robot supports limb movement depending on the force applied by the patient to the sensor.

The sensor in the thigh allows continuous monitoring of the force of lower limb pushing and pulling movements. The sensor is placed in a band fixing the patient's thigh to the robot frame. It allows measurement of the force of both flexion and extension movements.

In the device variant containing at least two force sensors in the foot base arranged linearly along the foot, where one sensor is under the heel and the other under the patient's toes, it is possible to control movement not only by foot pressure but also foot flexion. The robot can then simulate on the device the transition from heel to toe at the appropriate phase of walking.

An added rotational end piece allows for training rotation in the knee or hip.

The control system includes a wireless module that can be connected to an external muscle electrostimulation system or bioelectrical signal measurement system. Stimulation from a separate device allows for an increased number of EMG signal reading channels with limited reading channels (and synchronization). It is also possible to cooperate with another rail or other rehabilitation or electrostimulation device.

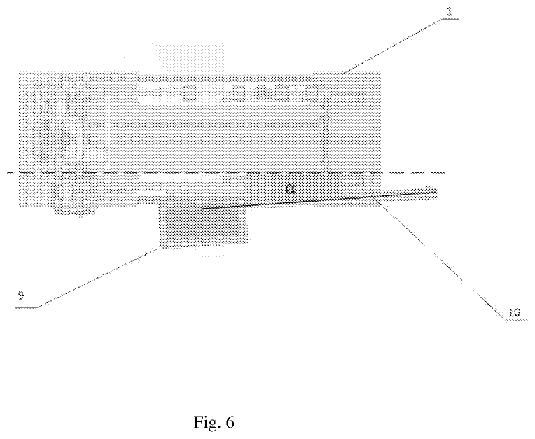

FIG. 6 shows the mounting of a tablet support bracket, allowing the tablet to be positioned in a way that facilitates data reading by the patient, and the bracket does not hinder the positioning of the patient's limb in the robot after folding.

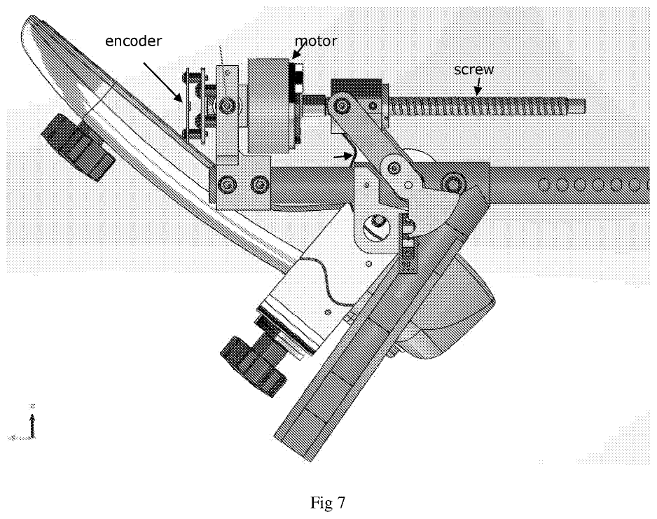

FIG. 7 shows the foot drive, which is implemented via a lead screw directly connected to the motor. Such a solution allows for generating torque and high speed with compact dimensions and low drive weight. The drive design allows for rotational movement within a range of less than one full rotation using a rocking linear drive mechanism. The system consists of a motor, rocking mechanism, guide, and lead screw with nut.

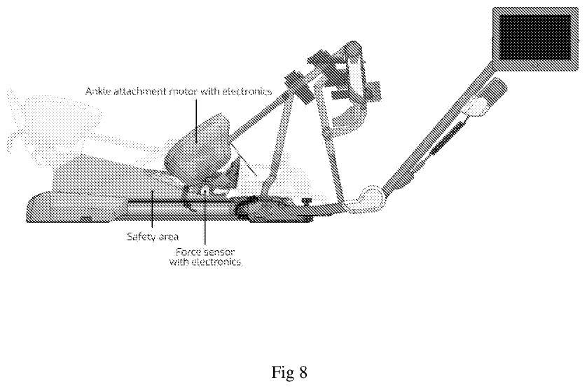

FIG. 8 shows the method of mounting drives and electronics on the rail in a way that creates space for performing robot movements regardless of the set parameters of the spacing of elements adapted to the length of the patient's leg. The device according to the invention provides the possibility of rehabilitating patients with lower limb movement dysfunctions, especially after joint twists and injuries, astronomy and arthroscopy, arthrolysis, or other intra-articular procedures, immobilization of the joint under anesthesia, operatively stabilized fractures, pseudo-joints, and joint setting surgeries, replacement plastics and reconstruction of cruciate ligaments, endoprosthesis implantations, and also for neurological patients, for example, after a stroke, spinal cord injury, or with multiple sclerosis.

The robot can operate in passive rail mode, active rail mode, or EMG signal-activated rail mode, including multi-channel EMG signals.

Functional movement patterns exercises are beneficial for the patient's recovery process. The robot according to the invention allows for the execution of functional movements performed by drives, where each serves for movement in a different axis. The drives are synchronized with each other in a functional movement pattern using control algorithms enabling movement within the appropriate range of lower limb joint mobility with the corresponding force or speed, corresponding, for example, to the walking and extension phases of the lower limb.

Synchronization of movement reflecting the gait phases or individual patient exercises such as squatting is possible thanks to the method of synchronizing the work of drives in which the drive actively leading the exercise generates movement depending on the robot's operating mode (active, passive, regulated by the EMG signal from muscles) and the second drive does not operate independently based on a pre-defined algorithm but follows the updated position and work method of the leading drive. Depending on the planned exercise of the established algorithm, each of the drives can play the leading role.

The given implementation example does not exhaust the possibilities of using the invention.

1. A lower limb rehabilitation robot comprising a base, a framework consisting of two main parts—a thigh support and a calf and foot support, which are interconnected by a joint, and at least one separate drive for each main part, as well as a control system, characterized that the operation of the drives (6,7) for the individual parts is controlled together by control system (8) and synchronized.

2. The robot according to claim 1, characterized that it includes a module for measuring the bioelectrical signal (11) from at least one muscle where the signal level triggers and controls the motor movement via the control system(8).

3. The robot according to claim 1, characterized that it includes a muscle electrostimulation module connected to the control system(8) such that the muscle stimulation sequence is synchronized with the robot's drive(6,7) movements according to movement patterns.

4. The robot according to claim 1, characterized that it includes a thigh band (12) with a force sensor and a force sensor mounted in the foot base(13) under the foot connected to the control system(8).

5. The robot according to claim 4, characterized that it includes at least two force sensors in the foot base arranged linearly along the foot, at least under the heel and the toes of the patient.

6. The robot according to claim 1, characterized that the control system (8) can be connected to an external muscle electrostimulation system or bioelectrical signal measurement system.

7. The robot according to claim 1, characterized that it has a display(9) in the form of a tablet on a bracket(10) directed towards the head of the exercising patient, with the possibility of mounting on both sides of the robot and folding along the robot.

8. The robot according to claim 1, characterized that the foot base (4) drive is implemented via a lead screw directly connected to the motor.

9. The robot according to claim 1, characterized that the drives in the robot are connected by a communication bus to the control system in a manner enabling continuous bidirectional signal transmission between the control system and the drives.

10. A method of synchronizing the drives of a rehabilitation robot for a lower limb comprising at least two drives, characterized that the drives are connected to one control system and one drive is a movement-defining drive and the other is passive, following the movement pattern of the first drive.

11. The method according to claim 10, characterized that each of the drives can function as an active movement-defining drive.
